(19) United States
(12) Patent Application Publication
(10) Pub. No.: US 2015/0223286 A1
(43) Pub. Date: Aug. 6, 2015

(54) SENSOR BRAIN FOR SIMPLE SENSORS IN A PROCESS CONTROL SYSTEM

(71) Applicant: Invensys Systems, Inc., Foxboro, MA (US)

(72) Inventors: Richard L. Linscott, Plainville, MA (US); Vincent Micheroni, Foxboro, MA (US)

(21) Appl. No.: 14/171,344

(22) Filed: Feb. 3, 2014

(51) Int. Cl. H04W 84/18; G01F 1/00

(52) U.S. Cl. CPC H04W 84/18; G01F 1/00

(57) ABSTRACT

A process control system that includes simple sensors which require little or no configuration and a separate sensor brain with which the simple sensors connect and communicate. The sensor brain receives raw data from the simple sensors and can process it as necessary to be used throughout the process control system. The result is a system where the sensors in the field are simple, fast and relatively cheap and the sensor brain can be larger and better at processing data as it does not have to be within close proximity to the process.

### BACKGROUND

The use of sensors throughout a process control system is vital for gathering data and monitoring a process. The efficiency of the process relies on the ability of the process control system to gather and process sensor data quickly and accurately.

Sensor devices typically gather data for one or more aspects of the process, process the data, and send the processed data to another part of the control system for use. These sensor devices require setup and configuration to ensure that the data will be processed and transmitted properly. Each individual sensor device must be configured and maintained. Because a typical process control system can make use of hundreds of sensor devices, engineers expend significant effort on set up and configuration throughout the process control system. Certain Foundation Fieldbus devices, for example, have been known to require configuration of over 100 different parameters at the individual device level. Additionally, processing the data at the sensor devices can slow down communications, including any responses that are necessary based on the sensor data. Moreover, such sensors are significantly more expensive than simple sensors.

A system that simplifies the operation of the individual sensors such that the sensors require minimal configuration and communicate raw data quickly and accurately would solve many of these issues.

### SUMMARY

Aspects of the invention relate to gathering and processing data from a process control system. Simple sensors are used to gather the raw data which is sent to a sensor brain which may be separate from the simple sensors. The sensor brain processes the raw data into a form that can be used within the process control system.

In an aspect of the system described herein, there is a process control system comprising a sensor brain and a sensor connected to each other. The sensor comprises a processor and a memory, the memory containing instructions executable on the processor. The instructions include instructions for self-configuring the sensor, instructions for identifying the sensor to the sensor brain, instructions for sensing process data, and instructions for communicating the sensed process data to the sensor brain. The sensor brain receives the sensed process data from the sensor and processes the process data for use in the process control system.

In another aspect, there is a sensor for sensing process data. The sensor comprises a sensor for sensing process data representative of at least one aspect of the process, a connector for communication with a sensor brain, a processor, and a memory. The memory contains instructions which are executable by the processor. The instructions comprise instructions for connecting to the sensor brain such that the sensor does not require configuration upon connection to the sensor brain, instructions for gathering process data from the process, and instructions for providing process data to the sensor brain.

In another aspect, there is a sensor brain for processing data in a process control system. The sensor brain comprises a processor, connectors for connecting to sensors, and a memory containing processor-executable instructions. The instructions comprise instructions for connecting to sensors, instructions for receiving raw process data from sensors, and instructions for processing raw process data for use in the process control system.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

The details of one or more implementations are set forth in the accompanying drawings and the description below. Other features will be apparent from the description and drawings, and from the claims.

### BRIEF DESCRIPTION OF DRAWINGS

FIG. 1 is a block diagram illustrating a configuration of a sensor device in a process control system in which a transmitter processes sensor data.

FIG. 2 is a block diagram illustrating a configuration according to an embodiment of the present invention including simple sensors and a sensor brain in a process control system.

FIG. 3 is a chart illustrating an exemplary interaction between a simple sensor and a sensor brain according to an embodiment of the present invention.

FIG. 4 is a diagram illustrating an exemplary configuration according to an embodiment of the present invention being used in a net oil computation skid system.

Corresponding reference characters indicate corresponding parts throughout the drawings.

### DETAILED DESCRIPTION

Aspects of the invention are directed toward a process control system that includes simple sensors and a sensor brain with which the simple sensors connect and communicate. Advantageously, the simple sensors require little or no configuration. The sensor brain receives raw data from the simple sensors and can process it as necessary to be used throughout the process control system.

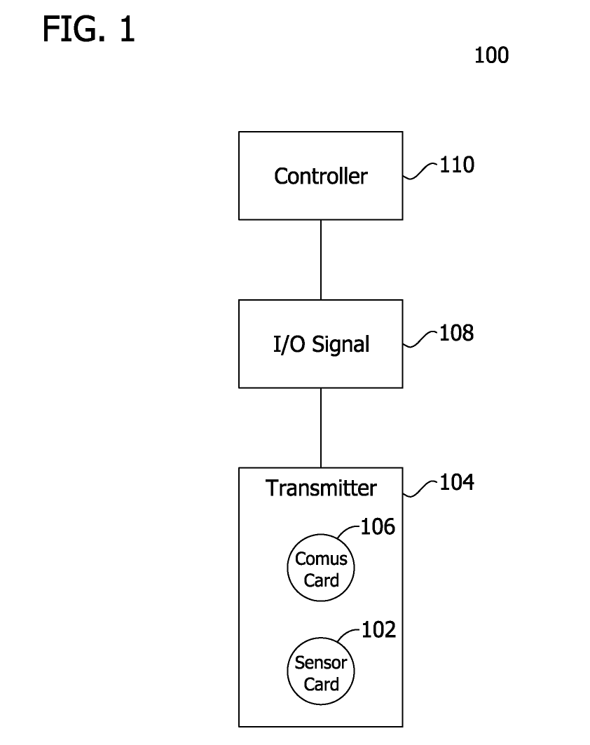

FIG. 1 is a block diagram illustrating a conventional configuration of a sensor device in a process control system. The system 100 contains a transmitter device 104, an I/O Signal device 108, and a controller 110. The transmitter 104 contains two circuit cards; a sensor card 102 and a communications card 106. In this configuration, the transmitter device 104 is placed in close proximity to the part of the process system that the sensor card 102 measures.

The transmitter 104 takes sensor data using the sensor card 102 and must process that data to convert it to engineering units or some other useful format. For instance, the raw data from the sensor may be converted into a type of function block output. Depending on the type of the transmitter, it may require significant additional configuration and maintenance based on the complexity of the device. The complexity of the transmitter 104 can also cause it to be quite expensive. The processing of the information by the transmitter 104 may limit the rate at which data is sampled from the process. A low data sampling rate can make monitoring the process more difficult and less accurate.

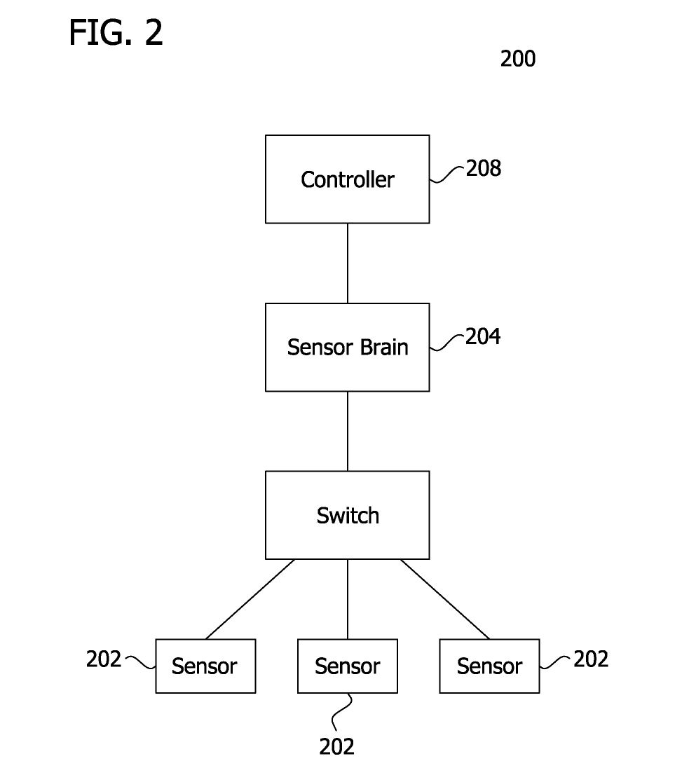

FIG. 2 shows a block diagram displaying an exemplary configuration of devices including simple sensors and a sensor brain in a process control system according to embodiments of the invention. The system 200 includes a plurality of simple sensors 202 which measure one or more aspects of the process control system in the form of raw sensed data. The simple sensors 202 represent a variety of possible sensors that can measure many different process variables, including, for instance, temperature, pressure, or flow rates. The simple sensors 202 gather raw data from the process and send it in its raw form with essentially no processing. In comparison to the sensor device 104 in FIG. 1, the simple sensors 202 are less complex and as a result are less expensive and require less maintenance. The simple sensors 202 are also able to provide data more quickly than the sensor device 104 in FIG. 1 as the simple sensors 202 do not process the data at the sensor level.

The simple sensors 202 are designed such that they require minimal or no configuration upon being connected to the process system. The simple sensors 202 have the ability to identify themselves to the system to which they connect and to gather data from the process system without initial configuration by a technician or other person. For instance, a simple sensor 202 that is made for measuring a temperature may be made up of several basic parts. It must have a part that measures the temperature of the process, for instance, a physical thermometer or infrared thermometer. The sensor has a small processor and a memory for storing very basic instructions that allow the sensor to understand communications from other devices. It also has a port that allowed for communication with another device. Upon connection to the process system, the simple sensor 202 identifies itself to the device on the other end of the connection and makes itself ready to gather temperature data and communicate with a device to which it is connected. The simple sensor 202 contains code that enables the simple sensor 202 to communicate its identity to other devices as well as gather data and send data to those other devices. The communication is according to a communication protocol for which the simple sensor 202 has been programmed and which the other connected devices can understand.

Using only a few basic parts allows for the simple sensor 202 to be compact and reliable. The parts included in each simple sensor 202 may vary based on the type of sensor and what the sensor is measuring. In an embodiment, it is contemplated that simple sensor 202 has more than one method of communication with other devices along with the stored instructions for doing so. In another embodiment, simple sensors 202 generate self-diagnostic data in the event that the sensor is damaged or malfunctioning. Simple sensors 202 in yet another embodiment are capable of low level control functions while still being in accord with the system described herein.

The simple sensors 202 are communicatively connected to a switch 206, which takes the data from the multiple sensors 202 and sends the data to the sensor brain 204. The connection between the simple sensors 202 and the switch 206 or the sensor brain 204 may be any sort of connection that fulfills the requirements of the sensor and switch or sensor brain based on the data being sent. Some examples of connection types include a point to point wired connection using a 4-20 mA current loop, a wireless connection, a power over Ethernet (POE) connection, or a polymer optic fiber (POF) connection. FIG. 2 is an exemplary diagram, but it is possible that a configuration of the present invention may be different in certain ways. For instance, the sensor brain 204 need not necessarily be separate from the switch device 206 or the simple sensors 202 may communicate directly with the sensor brain 204, bypassing the switch device 206.

A Power over Ethernet connection uses an Ethernet data cable to carry both power and data to a device. This technology has existed for several years, but only recently was a method developed that is considered “intrinsically safe” for use in powering process control devices in hazardous areas of a process plant. A simple sensor 202 using a POE connection permits transferring data back and forth to the sensor brain and powering the sensor by the same Ethernet cable.

A Polymer Optic Fiber connection uses an optic fiber to carry both data and power to the process devices in the form of beams of light. Once again, the technology used is considered safe to use in powering process control devices in hazardous areas of a process plant. A POF connection offers very high speeds of communication between the simple sensors 202 and the sensor brain 204.

The sensor brain 204 receives the raw data sent from the simple sensors 202. The sensor brain 204 then processes the raw data similar to how the transmitter 104 processed the data in FIG. 1. In one embodiment, this includes converting the raw data into engineering units or some other form that is compatible for use by the sensor brain 204 or a controller 208. Because the sensor brain 204 need not be embedded in tight spaces somewhere in the process system, it can be larger and include more powerful computing hardware than what would be used by transmitter 104 from FIG. 1. This allows the sensor brain 204 to more quickly process the data it receives and it allows the sensor information to be viewed at a single location rather than on the LCD of each sensor throughout the process system.

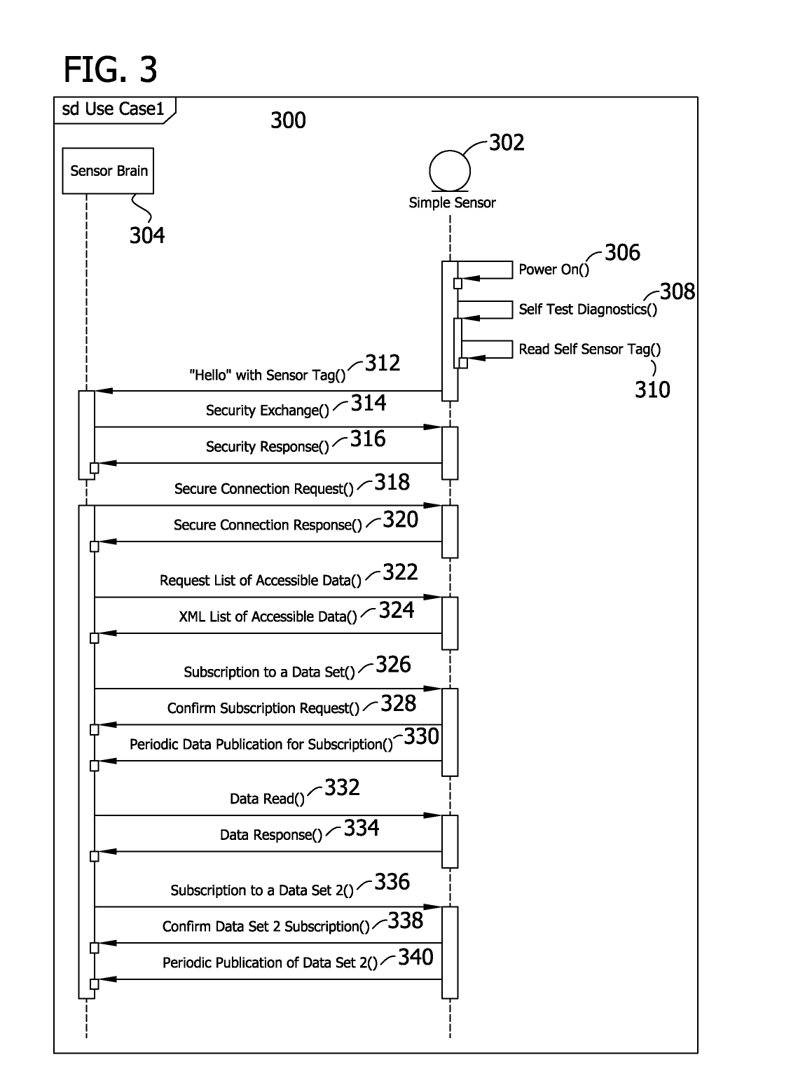

Upon connection by a simple sensor 202, the sensor brain 204 communicates with the simple sensor 202 to retrieve process data. The sensor brain 204 can subscribe to data that is being provided by the simple sensor 202, such that the simple sensor 202 will provide updated data to the sensor brain 204 periodically. The sensor brain 204 can also request data from the simple sensor 202 ad hoc and receive the desired data from the simple sensor 202 as requested. This is described in more detail later with respect to FIG. 3. The sensor brain 204 may receive diagnostic data from the simple sensor 202 in order to alert the proper user if the simple sensor 202 is damaged or malfunctioning in some way. It is also possible for the simple sensor 202 and the sensor brain 204 to communicate according to a different pattern that allows the sensor 202 and sensor brain 204 to exchange the necessary information and data to function according to this disclosure.

The sensor brain 204 may send processed data to a controller 208 to be used by the controller 208 to control the process system. The sensor brain 204 is likewise capable of providing data to multiple controllers as well, or the sensor brain 204 may also act as a controller using the processed data to control the system. The communication link between the sensor brain 204 and the controller 208 can be wired or wireless and may use any available protocol that allows for proper communication. The controller 208 may use the processed data it receives in the form it receives it, or it may process the received data in some other way. The controller 208 may receive different types of processed data from a single sensor brain 204 or multiple devices and the controller 208 may combine or use the different types of data received in concert in order to effectively control the process. The controller 208 may be connected to other sensors or devices that are not sensor brains as well as the sensor brain 204.

The sensor brain 204 in another embodiment may also function as a controller, receiving raw data from the simple sensors 202, processing it, and then using it to determine how to control the process. If the sensor brain 204 is also functioning as a controller, the sensor brain 204 may be connected to more conventional sensor transmitters as pictured in FIG. 1 as well as the simple sensors. The sensor brain 204 may also be connected to other devices that a controller 208 would regularly connect to. The connections between these devices can be wired or wireless and may use any protocol that allows for proper communications between the devices.

FIG. 3 shows a chart displaying an exemplary interaction 300 between a simple sensor 302 and a sensor brain 304. When the simple sensor 302 is first powered on 306, it does not require any external configuration. This enables a user to simply plug in the simple sensor 302; the user need not take any extra steps to initially set up and configure the simple sensor 302. The simple sensor 302 is capable of running diagnostics on itself 308 to ensure proper function and to determine its own sensor tag 310. With these steps completed, the simple sensor 302 is ready to connect to a sensor brain 304 and begin gathering sensor data. This assumes that the simple sensor 302 has been properly connected to the portion of the process from which it will be reading data. For gathering flow data, the sensor 302 will be connected to a pipe or tube that is part of the process, or for gathering temperature data, the sensor 302 may have a probe that must be oriented in the proper place within the process. Also, if the sensor 302 is to be connected to the sensor brain 304 via a wired connection, that connection must also be made.

Upon connection to the sensor brain 304, the simple sensor 302 sends a first communication with its unique sensor tag 312 so that the sensor brain 304 can properly communicate with the simple sensor 302. The simple sensor 302 and sensor brain 304 exchange any necessary security information in the form of messages 314 and 316. The simple sensor 302 and the sensor brain 304 then form a secure connection by exchanging messages 318 and 320. Once connected, sensor brain 304 requests a list of accessible data 322 from simple sensor 302. Simple sensor 302 provides a list 324. The sensor brain 304 subscribes to the set of accessible data it requires 326 and the simple sensor 302 confirms the subscription 328. The subscription can include not just the data, but also how often to send the data among other possible factors. Once the subscription process is complete, the simple sensor 302 periodically sends data 330 to the sensor brain 304. Additionally, the sensor brain 304 may just request data 332, to which the simple sensor 302 may respond with the requested data at that time 334. If the simple sensor 302 is gathering multiple types of data, the sensor brain 304 can subscribe to as many or as few types of data as necessary (see subscribing to additional data sets using messages 336, 338, and 340).

The interaction described in FIG. 3 is an example of how the simple sensors 302 and the sensor brain 304 may interact, but the order and method of interaction could be different and remain within the bounds of the present disclosure. It is not required that the sensor brain 304 be able to subscribe to data from the simple sensor as in step 326, so long as the sensor brain 304 can receive data from the simple sensor 302 in some way. The security handshake as shown by steps 314 and 316 may be important in certain embodiments, but they are not strictly necessary to implement the system described herein. As long as the sensor brain 304 and the sensor 302 can successfully communicate with each other, the steps of this process may occur in a different order, steps may be eliminated, or additional steps may be added.

Advantageously, the sensor brain 304 can connect to many different sensors as described above, and condition the raw data received from the sensors in different ways. Because the sensor brain 304 is aware of the unique sensor tag of each sensor, the data from different sensors may be modified or processed differently. A unique sensor tag is a number or other indicator that identifies a sensor. By including sensor tag information in the communications between a sensor and a sensor brain, the sensor brain can determine the source of the communication and process it based on that determination.

For example, a sensor brain 304 may be connected to more than one temperature sensor 302 at different points along a process, and each temperature sensor 302 may be providing data for a different purpose. For one temperature sensor 302, the sensor brain may merely receive the raw temperature data and process that into viewable information about the temperature of that part of the process. For another temperature sensor 302, the sensor brain may receive the raw temperature data and use that data in a more advanced process, such as determining when alarms or warnings should be displayed or predicting future behaviors of the process. Because each of the temperature sensors 302 have unique sensor tags which are known to the sensor brain 304, the sensor brain 304 can separate the two streams of raw temperature data and process them in different ways.

A specific example of an embodiment of this system employs simple sensors and a sensor brain in a configuration involving a net oil computation skid. A net oil computation skid refers to the functional components that provide the means for calculating the proportions of three separate mass flow rates (for instance, oil, water, and natural gas) as they flow together through a process tube. A variety of sensors are used to gather the information necessary to accurately compute the flow rates of the three different fluids. The sensors used in a net oil computation skid system may include, for example, pressure sensors, temperature sensors, Coriolis sensors, and water cut sensors. The use of the data gathered by the sensors in combination allows the system to accurately calculate flow rate of each type of fluid through the process tube. Calculating the flow rates of the fluids requires a relatively high amount of data processing. Because of this processing cost, a net oil computation skid system derives great benefit from a configuration that uses simple sensors and a sensor brain. The simple sensors are able to sample at a higher rate than the transmitters customarily used and the sensor brain can gather all the data and process it all at once, rather than processing being done by each transmitter. The use of a simple sensor/sensor brain configuration in a net oil computation skid system allows for increased accuracy and speed of calculation of the flow rates of the three fluids through the process tube.

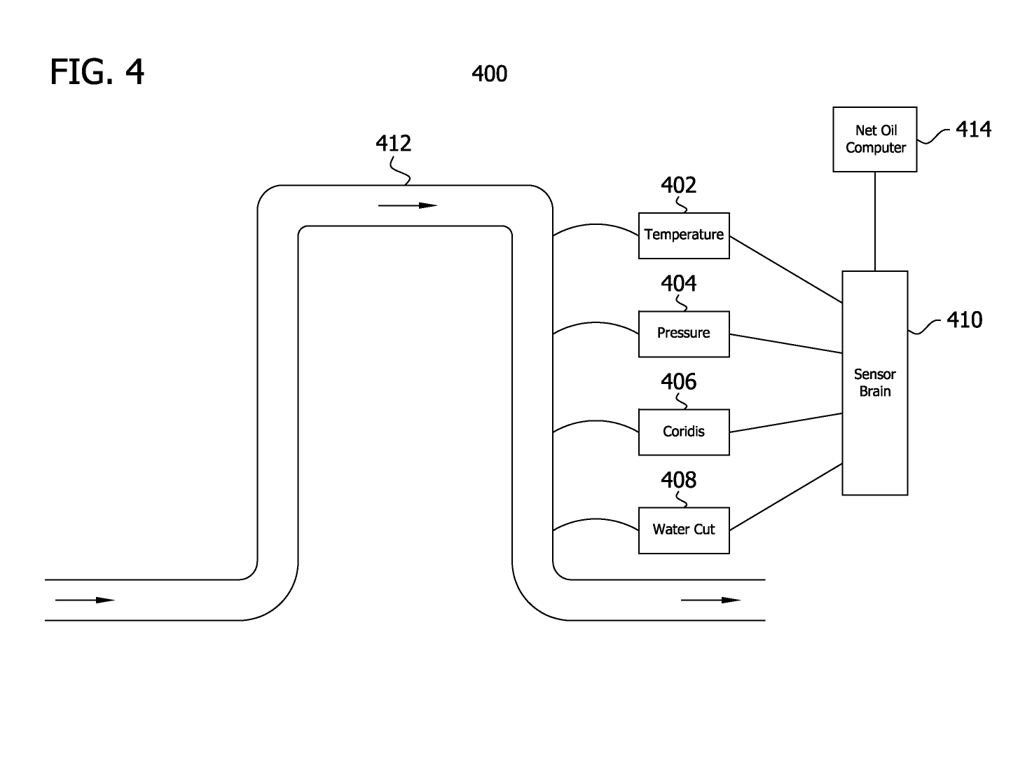

FIG. 4 displays a possible configuration of simple sensors and a sensor brain implemented in a net oil computation skid system 400. The simple sensors, including a temperature sensor 402, a pressure sensor 404, a Coriolis sensor 406, and a water cut sensor 408 are all connected to the process tube 412 such that the sensors are able to gather data from the process tube 412. Each sensor is connected to a sensor brain 410 such that the sensors can send the gathered data to the sensor brain 410 for processing. The possible means with which the sensors and the sensor brain 410 are connected were discussed previously. The sensor brain 410 may be connected to a net oil computer 414 which may do some of the data processing to properly calculate the flow rates of the fluids through the process tube 412.

An embodiment of the system described herein comprises a system for gathering data from a process and using that data to control the process. The system includes a sensor brain that is connected to one or more sensors and receives raw process data from the one or more sensors. The sensor brain processes the raw process data into a form that is useful for controlling the process. The system includes at least one sensor connected to the sensor brain. The sensor is simple such that it does little or no processing of the data it gathers and it requires little or no manual configuration upon connection to the process. The sensor gathers raw data and sends the raw data to the sensor brain for processing. The sensor brain and sensor may interact using a subscription method wherein the sensor brain subscribes to the data gathered by the sensor such that the sensor will send the sensor brain the data to which the sensor brain subscribed at regular intervals. The sensor brain may also request data from the sensor as it is needed by the sensor brain without subscribing to the sensor.

The order of execution or performance of the operations in embodiments of the invention illustrated and described herein is not essential, unless otherwise specified. That is, the operations may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

Embodiments of the invention may be implemented with computer-executable instructions stored in a non-transitory memory device. When executed by a computer, the computer-executable instructions embody aspects of the invention. The computer-executable instructions may be organized into one or more computer-executable components or modules. Aspects of the invention may be implemented with any number and organization of such components or modules. For example, aspects of the invention are not limited to the specific computer-executable instructions or the specific components or modules illustrated in the figures and described herein. Other embodiments of the invention may include different computer-executable instructions or components having more or less functionality than illustrated and described herein.

When introducing elements of aspects of the invention or the embodiments thereof, the articles “a,” “an,” “the,” and “said” are intended to mean that there are one or more of the elements. The terms “comprising,” “including,” and “having” are intended to be inclusive and mean that there may be additional elements other than the listed elements.

Having described aspects of the invention in detail, it will be apparent that modifications and variations are possible without departing from the scope of aspects of the invention as defined in the appended claims. As various changes could be made in the above constructions, products, and methods without departing from the scope of aspects of the invention, it is intended that all matter contained in the above description and shown in the accompanying drawings shall be interpreted as illustrative and not in a limiting sense.

What is claimed is:

1. A process control system comprising:
a sensor brain for processing raw process data for use in the process control system; and
a sensor communicatively connected to the sensor brain, said sensor sensing at least one aspect of a process and communicating the raw process data representative thereof to the sensor brain, said sensor comprising a processor and a memory, said memory storing instructions that, when executed by the processor:
self-configure the sensor for use in the process control system,
identify the sensor to the sensor brain, and
communicate the raw process data to the sensor brain.

2. The system of claim 1, wherein the memory in the sensor additionally stores instructions for allowing the sensor brain to subscribe to process data such that the sensor provides the raw process data to the sensor brain at regular intervals.

3. The system of claim 1, wherein the sensor and sensor brain are communicatively connected via a point to point wired connection using a 4-20 mA current loop.

4. The system of claim 1, wherein the sensor and the sensor brain are communicatively connected via a wireless protocol connection.

5. The system of claim 1, wherein the sensor and the sensor brain are communicatively connected via a Power over Ethernet connection.

6. The system of claim 1, wherein the sensor and the sensor brain are communicatively connected via a Polymer Optic Fiber connection.

7. The system of claim 1, further comprising a controller associated with the sensor brain that is connected to and controls one or more elements of the process control system, said controller using the processed data from the sensor brain to determine how to control said elements of the process control system.

8. A sensor brain for use in processing data in a process control system, said sensor brain comprising:
a processor;
one or more connectors communicatively connecting to one or more sensors; and
a memory containing processor-executable instructions, said instructions, when executed, causing the processor to:
connect to the sensors via the connectors;
receive raw process data from the connected sensors; and
process the raw process data for use in the process control system.

9. The sensor brain of claim 8, wherein the instructions on the memory additionally comprise instructions for sending subscription information to the sensor comprising the type of process data to send and at what interval to send it.

10. The sensor brain of claim 8, wherein the one or more connectors connect to sensors via a point to point wired connection using a 4-20 mA current loop.

11. The sensor brain of claim 8, wherein the one or more connectors connect to sensors using a wireless protocol connection.

12. The sensor brain of claim 8, wherein the one or more connectors connect to sensors using a Power over Ethernet connection.

13. The sensor brain of claim 8, wherein the one or more connectors connect to sensors using a Polymer Optic Fiber connection.

14. The sensor brain of claim 8, further comprising a controller that is connected to and controls one or more elements of the process control system, said controller using the processed data to determine how to control said elements of the process control system.

15. A net oil skid computation system for calculating flow rate of oil, water, and gas through a pipe, said net oil skid computation system comprising:
a sensor brain for processing raw process data; and
a plurality of sensors for sensing process data, said sensors configured to be communicatively connected to the sensor brain for communicating the sensed process data to the sensor brain, each of said sensors comprising a processor and a memory, said memory storing instructions comprising:
instructions for self-configuring the sensor,
instructions for identifying the sensor to the sensor brain,
instructions for sensing the process data, and
instructions for communicating the sensed process data to the sensor brain; and
the sensor brain receives the sensed process data from the sensors to which the sensor brain is communicatively connected and processes the sensed process data for use in the process control system.

16. The net oil skid computation system of claim 15, wherein a sensor in the plurality of sensors is a Coriolis sensor.
